(19) United States
(12) Patent Application Publication
(10) Pub. No.: US 2008/0105214 A1
(43) Pub. Date: May 8, 2008

(54) Retractable, locking leash device for pet animals

(76) Inventor: Reynolds Ellsworth Moulton, Brooklyn, NY (US)

Correspondence Address: Reynolds Ellsworth Moulton III, 591 Hicks Street, Brooklyn, NY, 11231, US

(21) Appl. No.: 11/594,683

(22) Filed: Nov. 8, 2006

(51) Int. Cl. A01K 27/00; B65H 75/48

(52) U.S. Cl. 119/796

(57) ABSTRACT

According to one embodiment, a retractable pet leash device is provided with a housing containing a storage part and a handle part. The storage part has a cavity to receive a reel to store a leash cord in a retractable or coiled condition. An aperture is provided in the wall of the storage part to permit the withdrawal of the leash cord or to retract the leash cord. A push button provided in the wall of the storage part is operated to retract the leash cord into the storage part. A hinged mechanism containing an elongate member is provided in the handle part provided with a notch portion to receive a stationary object so that the elongate member is pivotally moved to open and close the handle part around a stationary object. For objects of larger size, the leash cord is wound around the object to form a loop and locked into the handle part. Another push button is provided in the handle part to release the elongate member from the locked condition.

### A) TECHNICAL FIELD

This invention generally relates to pet leash devices and more particularly to a retractable locking leash device used to secure a pet animal such as dog, cat, etc to stationary objects such as a pole, small tree etc.

### B) BACKGROUND OF THIS INVENTION

At present pet owners have to tie a pet leash around an object, or slip the leash into a loop and tie the leash to secure a pet animal to stationary objects, when the pet owners want to tie and leave their pet temporarily for a short period to avoid the theft or escape of the animal. The leash tied in this manner can be easily untied during the pulling of the leash by pet animals, thereby generating the loss, theft or injury to the pet. Moreover the currently available standard leashes or retractable leash devices do not have a unique hinged boundary for opening and closing around objects. The currently available method for tying the pet animals is time consuming and potentially dangerous.

The U.S. Pat. No. 7,040,257 discloses a retractable leash device having a momentary unidirectional lock which is operated to prevent the rotation of the reel in a release direction but to permit the rotation of the reel in a retract direction.

The U.S. Pat. No. 6,845,737 discloses a combination ball and dog leash, having a ball formed integrally with a leash so that the leash is stored inside a housing and withdrawn through an aperture. A cap is tethered to a leash element so that the leash is withdrawn from the cavity of the housing, when the cap is removed.

The U.S. Pat. No. 6,532,903 discloses a locking leash and collar system having a pet securing region provided with two separated portions that are locked together or released from one another to permit the locking and the releasing of the pet.

The U.S. Pat. No. 6,276,305 discloses a compact dog leash having a leash attached to the bottom of a pouch and formed with several fold sections that are joined together by fold hinges so that the folded sections and hinges are adapted to permit the expansion and the contraction of the leash.

The U.S. Pat. No. 6,095,094 discloses a pet lock collar leash having an ergonomically designed leash handle to lock a loop of the leash around a fixture.

The U.S. Pat. No. 5,890,456 discloses a retractable animal leash device having a handle coupled to a housing in which a retractable elongated flexible leash is stored inside so that the free end of the leash is attached to an animal.

The U.S. Pat. No. 5,517,949 discloses an animal leash having a snap link provided with a gate attached to a base in the link through a spring loaded hinge so that the gate is pivoted inwardly to open the snap link to permit the attachment of the link to a collar or to a halter.

Thus none of the abovementioned prior art devices provides an easy, efficient and safe system for attaching the leash around stationary objects such as pole, small tree, etc.

### C) OBJECTS OF THE INVENTION

The primary object of this invention is to provide a locking retractable pet leash with a hinged component to enable a pet owner to tie and secure the pet animal around a stationary object easily, safely and efficiently.

Another object of this invention is to prevent the loss or theft of pet animal, when the pet animal is to be secured temporarily.

### D) SUMMARY OF THE INVENTION

The above mentioned shortcomings, disadvantageous and problems are addressed herein, which will be understood easily by reading and studying the following specification.

In one embodiment, a retractable, locking pet leash is provided with a housing containing a storage part, which is formed integrally with a handle part. A cavity is formed between a peripheral wall and the upper and the lower panels of the storage part to receive a reel to accommodate a leash cord in a retracted or coiled condition. An aperture is provided in one peripheral wall of the storage part to permit the withdrawal of the leash cord during the leash cord pulling out process or to retract the leash cord into storage part. A push button is provided in the peripheral wall of the storage part so that the push button is operated to retract the extended or pulled out leash cord or into the storage part.

The handle part has a hinged part provided in a peripheral wall surrounding a notch part into which a stationary object is to be inserted. The hinged part has a small elongated member pivotally connected to the peripheral wall. The elongated member is inserted into the recess arranged above and adjacent to the storage part in the housing to close the handle part. Another push button is provided in the peripheral wall of the storage part to release the elongated member from the recess and to pivotally move the elongate member to provide a room for inserting a stationary object. In one embodiment of this invention, the elongated member is pushed continuously until the elongated member is released from the recess by a spring action during the release of the locked housing from a stationary object. For larger objects, the leash cord is wound around the radius of larger objects to form a loop and is locked into the handle part to secure the leash device with larger objects. A handgrip is provided in the peripheral wall of the handle part in one embodiment to enable a pet owner or user to hold the leash device firmly and securely.

A connector unit such as a clip or a hook type arrangement is provided at one end of the leash cord to secure or fasten the leash cord with a collar of a pet animal or with a strip wound around the neck of a pet animal.

### E) BRIEF DESCRIPTION OF THE DRAWINGS

FIG. 1 shows a perspective view of a retractable locking pet leash device with a leash cord portion in pulled out condition, according to one embodiment of the present invention

FIG. 2 shows a front cut away view of the storage part in the retractable leash device according to one embodiment of this invention.

FIG. 3 shows a front view of a retractable pet leash device according to one embodiment, illustrated with a cut away view of a hinged part.

FIG. 4 shows a perspective view of a retractable, locking pet leash device according to one embodiment, in which the leash cord is pulled out from the storage part.

FIG. 5 shows a perspective of view of one embodiment of a retractable, locking pet leash device, which is wound around a pole.

FIG. 6 shows a perspective view of one embodiment of a retractable, locking pet leash device, in which the leash cord is tied around a tree.

Although specific features of this invention are shown in some drawings and not others; this is for convenience only as each feature may be combined with any or all of the other features in accordance with the invention.

### F) DETAILED DESCRIPTION OF THE PREFERRED EMBODIMENTS

In the following detailed description, a reference is made to the accompanying drawings that form a part hereof, and in which is shown by way of illustration the specific embodiments, which may be practiced. These embodiments are described in sufficient detail to enable those skilled in the art to practice the embodiments, and it is to be understood that logical, mechanical and other changes may be made without departing from the scope of the embodiments. The following detailed description is, therefore, not to be taken in a limiting sense.

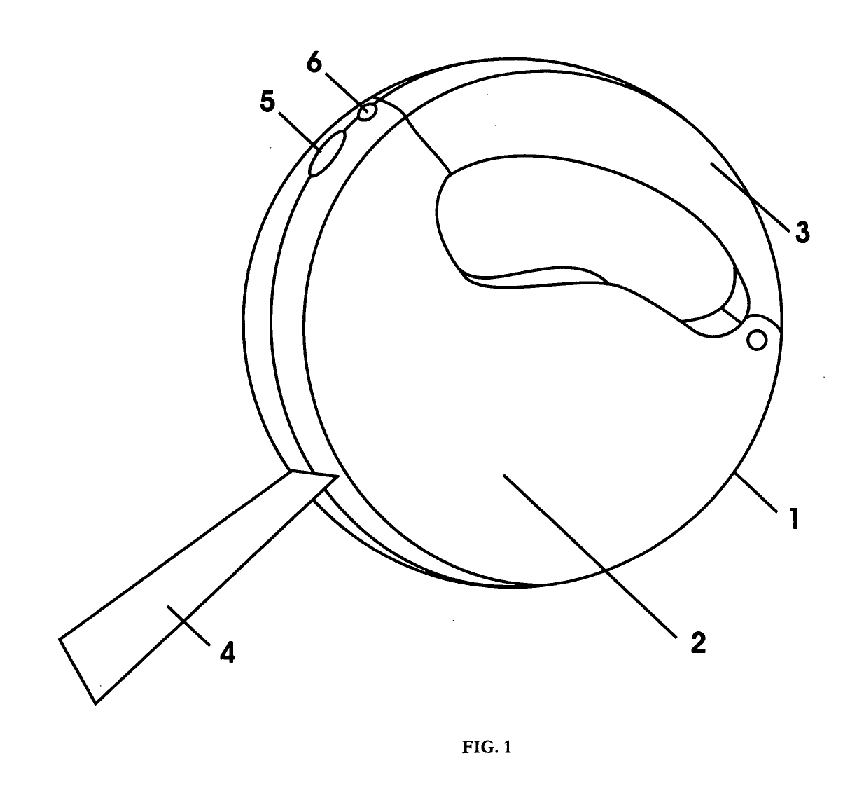

A preferred embodiment of this invention provides a retractable leash device with a hinged component in the handle part for fastening the pet animal such as dogs, cats, etc., around stationary objects for example pole, small tree etc. The FIG. 1 shows a perspective view of a retractable locking leash device according to one embodiment. Referring to FIG. 1-FIG. 3 the device has a housing 1 containing a storage part 2 and a handle part 3. The storage part 2, which is formed integrally with the handle part 3, comprises a peripheral wall, an upper panel and a lower panel. A cavity is formed between the peripheral wall and the upper and the lower panels in the storage part 2. A reel is provided in the storage part 2 to store the leash cord 4 in a retracted or coiled condition. An aperture is provided in the peripheral wall of the storage part 2 so that the leash cord 4 is pulled out through the aperture or retracted into the storage part 2. A push button 5 is provided on the peripheral wall of the storage part 2 so that the push button 5 is activated to retract the extended leash cord 4 into the storage part 2. Thus the push button 5 is operated to control the movement of the leash cord 4 to extend the leash cord 4 for a desired length.

The handle part 3 is provided with a notch part having an opening surrounded by a peripheral wall. A stationary object such as a pole, a small tree etc., is inserted into the opening of the notch part for tying the leash device with the stationary object. The hand of a user or the owner of a pet animal is inserted into the opening of the notch part to hold the leash device in hand firmly, when the leash device is not tied to the handle. A hinged part is provided in the handle part 3 to open and close the handle part 3 around a stationary object. The hinged part has an elongated member 7 pivotally connected to one end of the peripheral wall surrounding the opening in the notch part at the handle part 3. A recess is provided in the area, which is adjacent to and arranged above the storage part 2 so that the elongated member 7 provided in the hinged part is inserted into the recess to close the handle part 3. The elongated member 7 is inserted inside the recess to lock the leash device with the stationary object. In an embodiment of this invention, the elongated member 7 is a rectangular or cylindrical bar. The bar may be made up of a sturdy, hard and durable material including a metal, plastic etc. In an embodiment of this invention, the elongated member has serrated edge at one side or provided with teethed structure at one side to enable the locking of the elongated member inside the recess. Another push button 6 is provided in the peripheral wall surrounding the handle part 3 to release the elongated member 7 from the recess and to pivotally move the elongated member 7 to open and close the handle part 3 around a stationary object such as a pole, a small tree etc., to tie the leash device with the stationary object. For tying the leash cord device with a stationary object of larger size, the leash cord 4 is wound around the stationary object of larger size, to form a loop and locked into the handle part 3. The locked leash device is released in one embodiment of this invention by the spring action of the elongated member 7 by inserting the elongated member 7 inside the recess continually until the elongated member 7 is released. In another embodiment of this invention, the locked pet leash device is released by pressing another button 6, which is different from the button provided for releasing the leash cord 4 from the storage part 2. A handgrip is provided in a peripheral wall surrounding the notch part to hold the leash device firmly and securely in one embodiment of this invention.

A connector part such as a clip or a hook type arrangement is provided at one end of the leash cord 4 to permit the fastening of the leash cord 4 with the collar of the pet animal or with the strip provided around the neck of the pet animal. In one embodiment of this invention, the leash cord 4 is made up of leather material. In another embodiment of this invention, the leash cord 4 is made up of cloth. However the leash cord 4 may be made up of any resilient, flexible, and durable materials.

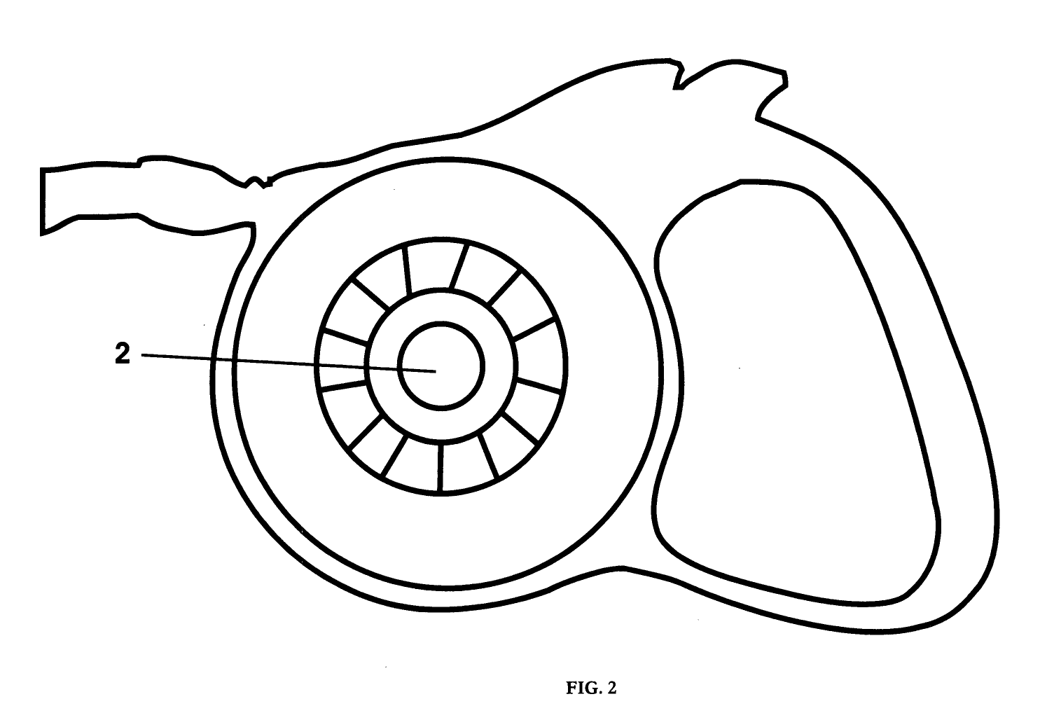

The FIG. 2 shows a partial front view of storage part 2 in a retractable locking pet leash according to one embodiment. The storage part 2 has a reel provided in the cavity to store the leash cord in a retracted or coiled condition.

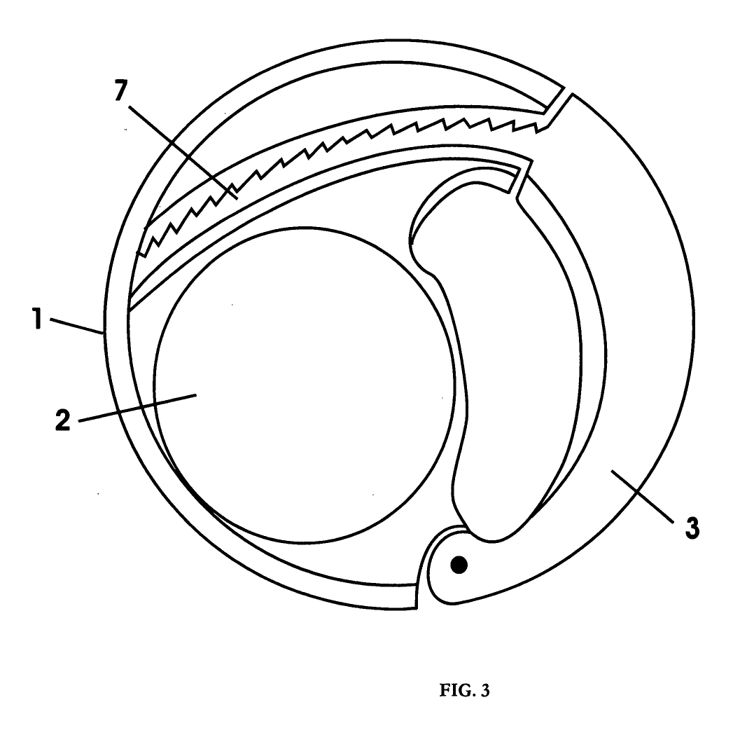

The FIG. 3 shows a front view of a retractable pet leash device according to one embodiment of this invention. With reference to FIG. 3, the retractable pet leash device has a housing 1 provided with a storage part 2 and a handle part 3. The handle part 3 has a notch part provided with an opening for receiving a stationary object. The hinged mechanism provided in the handle part 3 has an elongated member 7 pivotally connected to one end of the peripheral wall surrounding the notch part. The elongated member 7 having serrated edge or teethed structure at one side, is inserted and received in a recess provided in an area, which is arranged adjacent to and above the storage part 2 to store the handle part 3 in a locked condition.

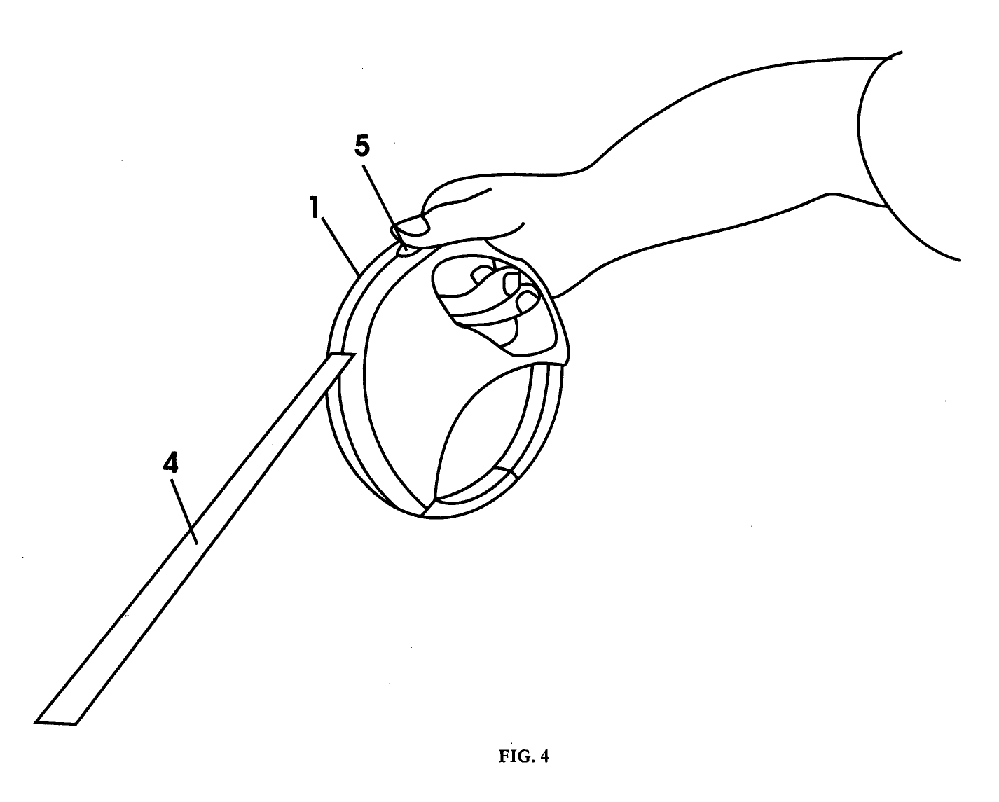

The FIG. 4 shows a perspective view of a retractable locking pet leash device according to one embodiment of this invention. Referring to the FIG. 4, the retractable locking pet leash device has a housing 4 provided with storage part 2 and a handle part 3. The storage part has a hollow portion surrounded by a peripheral wall. The leash cord 4 is stored in the hollow portion at the storage part 2 in a coiled condition. The storage part 2 has an aperture provided on a peripheral wall to permit the withdrawal or the retreat of a pulled out or extended leash cord 4 into the storage part 1. A push button 5 is provided on a peripheral wall of the storage part so that the push button is operated to retract the leash cord into storage part 2. The handle part 3 has two notches provided respectively with opening parts to receive a hand of a user and to receive a stationary object around which a leash or a pet animal is to be tied. The handle part 3 has a hinged component provided in the peripheral wall surrounding one notched opening part arranged to receive a stationary object so that the peripheral wall is pivotally moved to open and dose the handle part 3 around a stationary object. The examples of the stationary objects are a small tree, a pole etc. A handgrip is provided in another notched opening part arranged to receive the hand of a user to hold the retractable leash device firmly and securely.

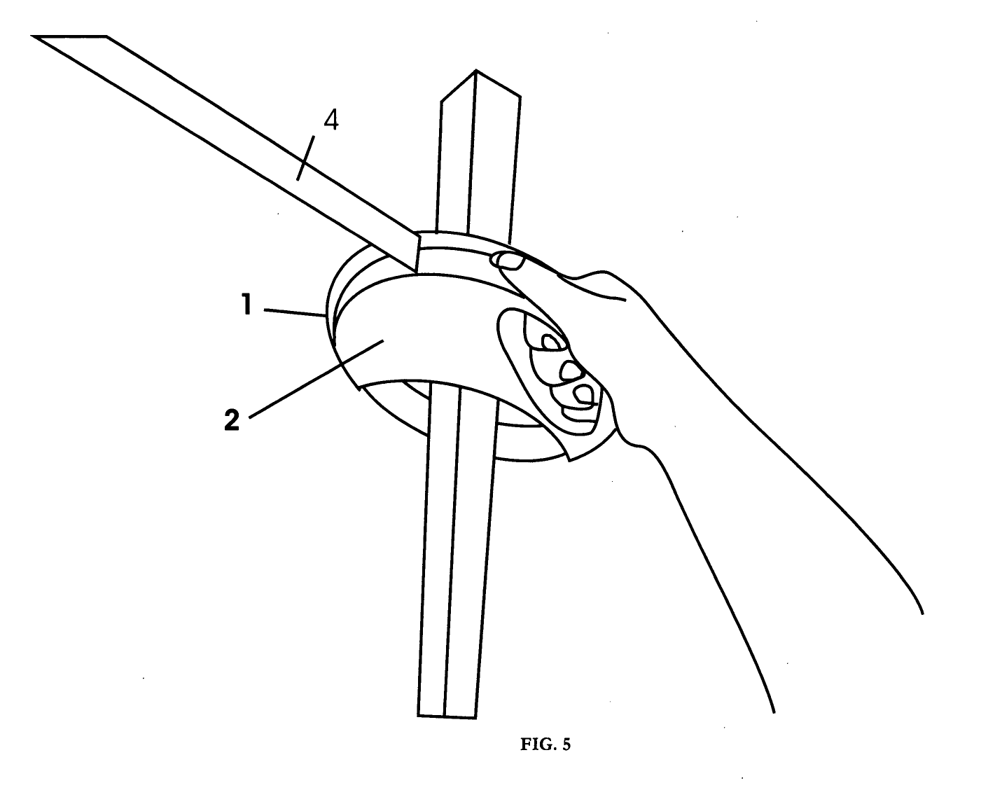

The FIG. 5 shows a perspective view of a retractable, locking pet leash according to one embodiment. The retractable locking pet leash device is secured around a stationary object such as a pole, by opening and closing the wall in the handle part using the hinged component provided in the wall.

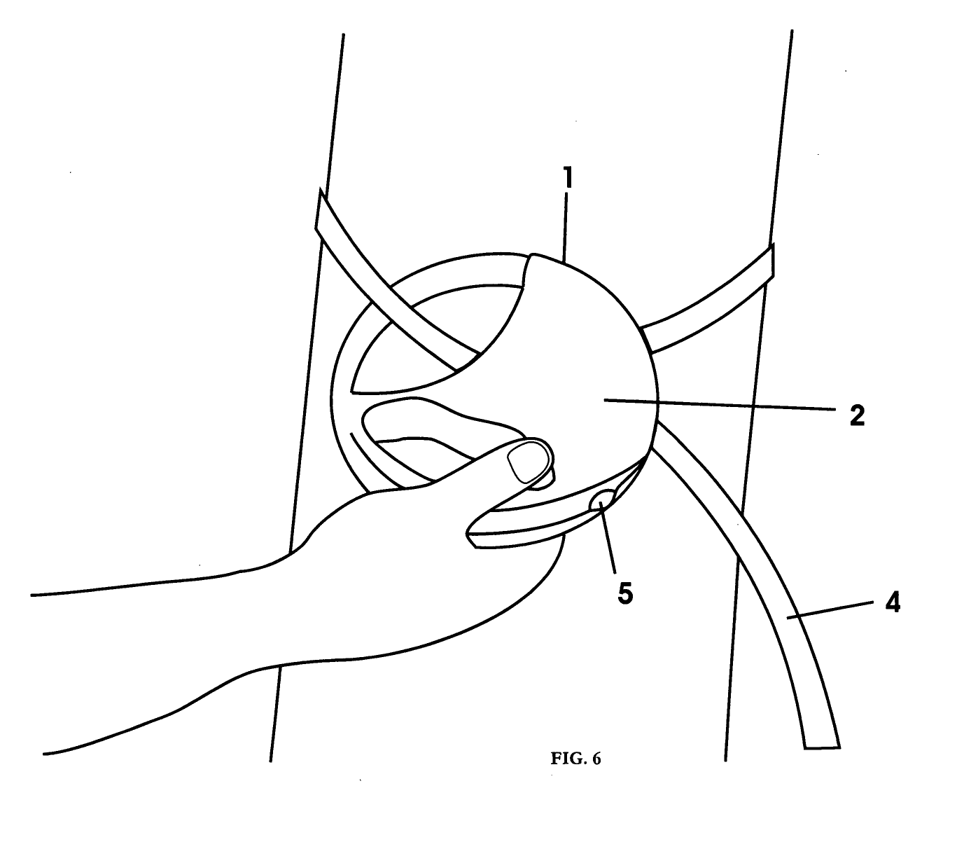

The FIG. 6 shows a perspective view of a retractable locking pet leash device according to one embodiment of this invention. The leash cord 4 is pulled out to wound around the radius of larger objects like a tree to form a loop and locked into the handle part.

It will be obvious for a person skilled in the art to practice the invention with modifications. However, all the modifications will be deemed to be covered within the scope of this invention as covered in the claims hereunder.

What is claimed is:

1. A retractable locking leash device for pet animals, comprising:
a) A housing;
b) A storage part provided in the housing to accommodate a leash cord in a retracted condition;
c) A handle part formed integrally with the storage part
d) A hinged part provided in the handle part to pivotally move the handle part;
e) Wherein the handle part is pivotally moved around the hinged part to open and close around a stationary object.

2. A retractable leash device according to claim 1, wherein the handle part consists of a notch part provided with an opening for receiving a stationary object and a peripheral wall surrounding the notch part.

3. A retractable leash device according to claim 1, wherein the hinged part has an elongated member pivotally connected to one end of a peripheral wall surrounding the notch part of the handle part so that the elongated member is pivotally moved to open and close the handle part around a stationary object.

4. A retractable leash device according to claim 1, wherein a recess is provided in an area, which is arranged adjacent to and above the storage part so that the elongated member is inserted into the recess to close the handle part to enable the locking of the housing with the stationary object.

5. A retractable leash device according to claim 1, wherein the leash cord is wound around the objects of larger size to form a loop and locked into the handle part to lock the housing with the objects of larger size.

6. A retractable leash device according to claim 1, further comprising a push button provided in the peripheral wall of the handle part so that the push button is provided at the peripheral wall of the housing so that the push button is operated to permit the release of the elongated member from the recess and to pivotally move the elongated member to open and close the handle part around a stationary object.

7. A retractable leash device according to claim 1, wherein the elongated member is a rectangular bar.

8. A retractable leash device according to claim 1, wherein the elongated member is a cylindrical rod.

9. A retractable leash device according to claim 1, wherein the elongated member has serrated edge or teethed structure at one side.

10. A retractable leash device according to claim 1, wherein the storage part has a peripheral wall, an upper panel and a lower panel.

11. A retractable leash device according to claim 1, wherein the storage part is provided with a cavity formed between the peripheral wall and the upper and the lower panels to store the leash cord in a coiled or retracted condition.

12. A retractable leash device according to claim 1, wherein a reel is provided in the cavity at the storage part to store the leash cord in a coiled or retracted condition.

13. A retractable leash device according to claim 1, wherein the storage part is provided with an aperture in the peripheral wall so that the leash cord is pulled out through the aperture or retracted into the storage part.

14. A retractable leash device according to claim 1, wherein the storage part is provided with another push button at the peripheral wall so that the push button is operated to retract the extended or pulled out cord into the storage part.

15. A retractable leash device according to claim 1, wherein a handgrip is provided in the peripheral wall surrounding the notched part of the handle part.

16. A retractable leash device according to claim 1, wherein a connector means is provided at one end of the leash cord to fasten the leash cord with the collar of a pet animal.

17. A retractable leash device according to claim 1, wherein a connector means is secured to a neck strip provided around the collar of a pet animal.

18. A retractable leash device according to claim 1, wherein the connector means is a clip provided at one end of a leash cord.

19. A retractable leash device according to claim 1, wherein the connector means is a hook type arrangement provided at one end of the leash cord.

20. A retractable leash device according to claim 1, wherein the stationary object is a pole.

21. A retractable leash device according to claim 1, wherein the stationary object is a small tree.

22. A retractable locking leash device for pet animals, comprising:
a) A housing;
b) A storage part provided in the housing to accommodate a leash cord in a retracted condition;
c) A handle part formed integrally with the storage part
d) A hinged part provided in the handle part to pivotally move the handle part;
e) Wherein the handle part is pivotally moved around the hinged part to open and close around a stationary object.

23. A retractable leash device according to claim 22, wherein the handle part consists of a notch part provided with an opening for receiving a stationary object and a peripheral wall surrounding the notch part.

24. A retractable leash device according to claim 22, wherein the hinged part has an elongated member pivotally connected to one end of a peripheral wall surrounding the notch part of the handle part so that the elongated member is pivotally moved to open and close the handle part around a stationary object.

25. A retractable leash device, according to claim 22, wherein a recess is provided in an area, which is arranged adjacent to and above the storage part so that the elongated member is inserted into the recess to close the handle part to enable the locking of the housing with the stationary object.

26. A retractable leash device according to claim 22, wherein the leash cord is wound around the objects of larger size to form a loop and locked into the handle part to lock the housing with the objects of larger size.

27. A retractable leash device, according to claim 22, further comprising a push button provided in the peripheral wall of the handle part so that the push button is operated to permit the release of the elongated member from the recess and to pivotally move the elongated member to open and close the handle part around a stationary object.

28. A retractable leash device according to claim 22, wherein the elongated member is pushed into the recess continuously until the elongated member is released from the recess by the spring action.

29. A retractable leash device according to claim 22, wherein the elongated member is a rectangular bar.

30. A retractable leash device according to claim 22, wherein the elongated member is a cylindrical rod.

31. A retractable leash device according to claim 22, wherein the elongated member has serrated edge or teethed structure at one side.

32. A retractable leash device according to claim 22, wherein the storage part has a peripheral wall, an upper panel and a lower panel.

33. A retractable leash device according to claim 22, wherein the storage part is provided with a cavity formed between the peripheral wall and the upper and the lower panels to store the leash cord in a coiled or retracted condition.

34. A retractable leash device according to claim 22, wherein a reel is provided in the cavity at the storage part to store the leash cord in a coiled or retracted condition.

35. A retractable leash device according to claim 22, wherein the storage part is provided with an aperture in the peripheral wall so that the leash cord is pulled out through the aperture or retracted into the storage part.

36. A retractable leash device according to claim 22, wherein the storage part is provided with another push button at the peripheral wall so that the push button is operated to retract the extended or pulled out cord into the storage part.

37. A retractable leash device according to claim 22, wherein a handgrip is provided in the peripheral wall surrounding the notched part of the handle part.

38. A retractable leash device according to claim 22, wherein a connector means is provided at one end of the leash cord to fasten the leash cord with the collar of a pet animal.

39. A retractable leash device according to claim 22, wherein a connector means is secured to a neck strip provided around the collar of a pet animal.

40. A retractable leash device according to claim 22, wherein the connector means is a clip provided at one end of a leash cord.

41. A retractable leash device according to claim 22, wherein the connector means is a hook type arrangement provided at one end of the leash cord.

42. A retractable leash device according to claim 22, wherein the stationary object is a pole.

43. A retractable leash device according to claim 22, wherein the stationary object is a small tree.

44. A retractable leash device for pet animals, comprising:
a) A housing;
b) A storage part provided in the housing to accommodate a leash cord in a retracted condition;
c) A handle part formed integrally with the storage part;
d) A hinged part provided in the handle part to pivotally move the handle part;
e) Wherein the handle part is pivotally moved by the hinged part to open and close around a stationary object.

45. A retractable leash device according to claim 44, wherein the handle part consists of two notches provided respectively with an opening part for receiving a stationary object and for receiving a hand of a pet owner or a user.

46. A retractable leash device according to claim 44, wherein the hinged part is provided at a peripheral wall surrounding an opening part in one notch used for inserting a stationary object so that the peripheral wall surrounding the opening part in one notch is pivotally moved to receive and hold a stationary object.

47. A retractable leash device, according to claim 44, wherein a handgrip is provided in an opening at another notch arranged for receiving the hand of a user.

48. A retractable leash device, according to claim 44, wherein a push button is provided in the peripheral wall of the handle part so that the push button is operated to permit the retraction of a pulled out or extended leash cord into the storage area.

49. A retractable leash device according to claim 44, wherein the storage part has a peripheral wall and an upper panel and a lower panel.

50. A retractable leash device according to claim 44, wherein the storage part is provided with a cavity formed between the peripheral wall and the upper and the lower panels to store the leash cord in a coiled or retracted condition.

51. A retractable leash device according to claim 44, wherein a reel is provided in the cavity at the storage part to store the leash cord in a coiled or retracted condition.

52. A retractable leash device according to claim 44, wherein the storage part is provided with an aperture in the peripheral wall so that the leash cord is pulled out through the aperture or retracted into the storage part.

53. A retractable leash device according to claim 44, wherein a connector means is provided at one end of the leash cord to fasten the leash cord with the collar of a pet animal.

54. A retractable leash device according to claim 44, wherein a connector means is secured to a neck strip provided around the collar of a pet animal.

55. A retractable leash device according to claim 44, wherein the connector means is a clip provided at one end of a leash cord.

56. A retractable leash device according to claim 44, wherein the connector means is a hook type arrangement provided at one end of the leash cord.

57. A retractable leash device according to claim 44, wherein the stationary object is a pole.

58. A retractable leash device according to claim 44, wherein the stationary object is a small tree.
